(19) United States
(12) Patent Application Publication
(10) Pub. No.: US 2025/0095690 A1
(43) Pub. Date: Mar. 20, 2025

(54) Automatic Generation of Support Video from Source Video

(71) Applicant: Google LLC, Mountain View, CA (US)

(72) Inventors: Pei-Yu Chi, Menlo Park, CA (US); Sen-Po Hu, Menlo Park, CA (US); Irfan Aziz Essa, Atlanta, GA (US); Tao Dong, Cupertino, CA (US)

(21) Appl. No.: 18/886,486

(22) Filed: Sep. 16, 2024

Related U.S. Application Data
(60) Provisional application No. 63/582,692, filed on Sep. 14, 2023.

(51) Int. Cl. G11B 27/031; G06F 40/166; G06F 40/40; G06T 13/20; G06T 13/40; G06V 20/50; G06V 40/16; G11B 27/34

(52) U.S. Cl. CPC G11B 27/031; G06F 40/166; G06F 40/40; G06T 13/205; G06T 13/40; G06V 20/50; G06V 40/161; G11B 27/34

(57) ABSTRACT

Provided are systems and methods for the automatic generation of support videos from a source video. For example, the support video can more deeply explain or elaborate upon content included in source video. In particular, a computing system can obtain a source video and extract one or more sets of textual content associated with the source video. For example, the sets of textual content can include a transcript of speech that occurs within the source video. The computing system can process the one or more sets of textual content with a generative sequence processing model to generate, as an output of the generative sequence processing model, additional textual content for a support video.

### RELATED APPLICATIONS

This application claims priority to and the benefit of U.S. Provisional Patent Application No. 63/582,692, filed Sep. 14, 2023. U.S. Provisional Patent Application No. 63/582,692 is hereby incorporated by reference in its entirety.

### FIELD

The present disclosure relates generally to video generation. More particularly, the present disclosure relates to systems and methods for the automatic generation of support videos from a source video.

### BACKGROUND

With the rise of digital technology and the availability of internet access, users increasingly turn to online video platforms to learn about a myriad of topics and concepts. The visual and auditory nature of video content can significantly aid in the understanding and retention of knowledge, especially when these topics are complex or challenging. As a consequence, platforms offering educational videos have become critical tools for students, professionals, and other individuals.

However, a recurrent challenge faced by these users is the potential redundancy or ineffectiveness of certain videos. To gain a holistic understanding or to clarify challenging topics, a user might view multiple videos, hoping each will provide a unique perspective or clearer explanation than the last. Unfortunately, this approach often leads to the user watching several videos that overlap considerably in content or, worse, videos that do not provide the desired information or clarity.

This redundancy does not merely lead to wasted time and frustration for the user. From a computational perspective, playing these additional, redundant, or unhelpful videos unnecessarily consumes significant computational resources. Such consumption includes processor usage, as videos need decoding; memory usage, where videos are buffered; and network bandwidth, which is especially pertinent for users with limited data plans or those accessing content from regions with less robust network infrastructure.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for automatic video generation. The method includes obtaining, by a computing system comprising one or more computing devices, a source video. The method includes extracting, by the computing system, one or more sets of textual content associated with the source video. The method includes processing, by the computing system, the one or more sets of textual content with a generative sequence processing model to generate, as an output of the generative sequence processing model, additional textual content for a support video. The method includes inputting, by the computing system, the additional textual content to a video generation algorithm to automatically generate the support video.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1A-F depict graphical diagrams of example user interfaces according to example embodiments of the present disclosure.

FIG. 2 depicts a graphical diagram of an example data flow for automatically generating a support video from a source video according to example embodiments of the present disclosure.

FIG. 3 depicts a graphical diagram of an example approach for automatically matching video segments with portions of a narration according to example embodiments of the present disclosure.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to systems and methods for the automatic generation of support videos from a source video. For example, the support video can more deeply explain or elaborate upon content included in source video. In particular, a computing system can obtain a source video and extract one or more sets of textual content associated with the source video. For example, the sets of textual content can include a transcript of speech that occurs within the source video, textual content from linked documents, textual metadata, or other forms of textual information associated with the source video. The computing system can process the one or more sets of textual content with a generative sequence processing model to generate, as an output of the generative sequence processing model, additional textual content for a support video. For example, the additional textual content can be an additional summarization, explanation, or other elaboration on the content of the original source video. In addition, the computing system can extract visual content from the source video, such as information about visual style, logos, faces, shot types, etc. The computing system can then input the additional textual content and/or the visual content to a video generation algorithm to automatically generate the support video. For example, the support video can be a video that presents the additional summarization, explanation, or other elaboration on the content of the original source video. The computing system can then provide an option to view the support video during playback of the source video. In such manner, a user can be provided with an opportunity to more deeply explore and understand complex or interesting topics or concepts that are included within the source video.

Thus, example aspects of the present disclosure are directed to systems and methods that automatically generate short-length videos the support the content included in a primary source video. As examples, the support videos can be previews, concept explanation, and/or questions and answers relating to the content included in the source video. According to one aspect, the proposed system can leverage a generative sequence processing model (e.g., a so-called “large language model”) to generate additional video content that forms the basis of the support video based on information (e.g., textual and/or visual content) extracted from the source video. The proposed video generation pipeline can also make prompting and editing decisions to generate support videos that have a similar look-and-feel to the source video. In one example interactive player, viewers can follow the main source video and can pause to review support videos relevant to that moment, while being engaged in video following.

More particularly, tutorial videos are a popular way for learners to follow a new concept via verbal and visual guidance from an instructor. Compared to a tutorial document, videos better engage learners via demonstrations with verbal dialogues. As one example, in the programming domain, instructors often walk through incremental code examples with visual aids in a video. They commonly use transitions, animations, and highlights. They may also provide links to one or several code playgrounds, API documents, and/or web tutorials as additional references.

When following video content, learners may pause in between to search online for additional information from a document, glance through a related video, or read or test the sample code. These actions typically happen outside of the video player, which results in computational resources being expended by switching between different applications (e.g., between a browser application and a video play application) and/or between different tabs or windows of the same application. Switching between different applications or windows consumes processor cycles and memory usage. Therefore, preventing such unnecessary switching and, more generally, reducing the consumption of redundant

As a technical solution to this problem, the present disclosure provides systems and methods (example implementations of which can be referred to as “Video2Video”) which automatically generates short-length videos to support the main video content. Some example implementations can extract textual content (e.g., transcripts, metadata, linked documents, user-generated content, etc.) and/or visual content (e.g., faces, styles, icons, logo, scene types, etc.) from the source video. The proposed system can then prompt a generative sequence processing model (e.g., an LLM) to generate additional relevant content, such as, for example, summaries, concept explanations, and/or questions and answers. A new support video can then be generated based on the additional relevant content. For example, the support video can be generated with the same or similar style or visual look and feel.

Then, in some implementations, within an interactive player, viewers can be enabled to follow the source video and pause to review support videos that are relevant to content being presented at that moment within the source video, all while remaining engaged in the same video player interface. As such, unnecessary switching between applications or windows can be reduced. Similarly, the viewer can drill in on specific content, reducing the number of redundant or off-topic videos that are consumed. Each of these improvements conserves computational resources such as processor cycles, memory usage, network bandwidth, etc., and therefore represents a technical effect that provides a technical benefit.

With reference now to the Figures, example embodiments of the present disclosure will be discussed in further detail.

### Example Video User Interfaces

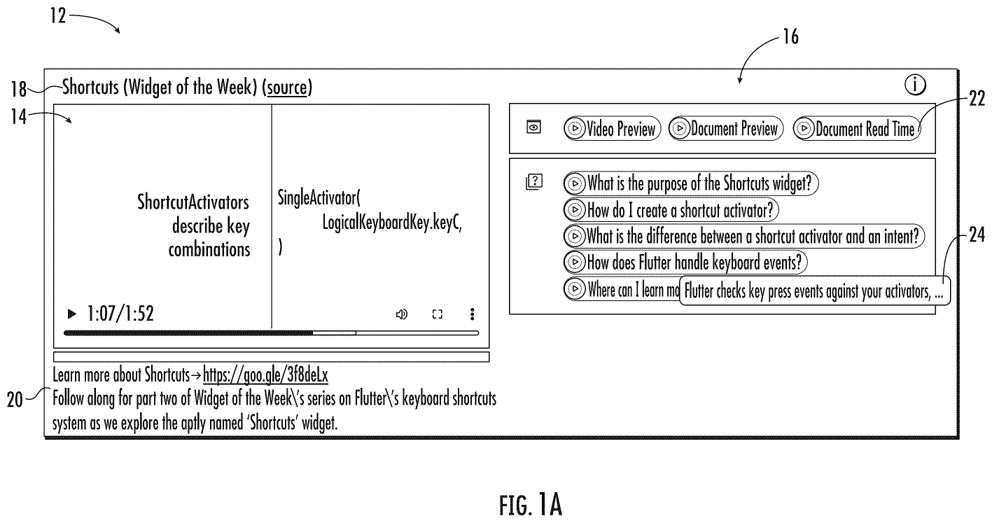

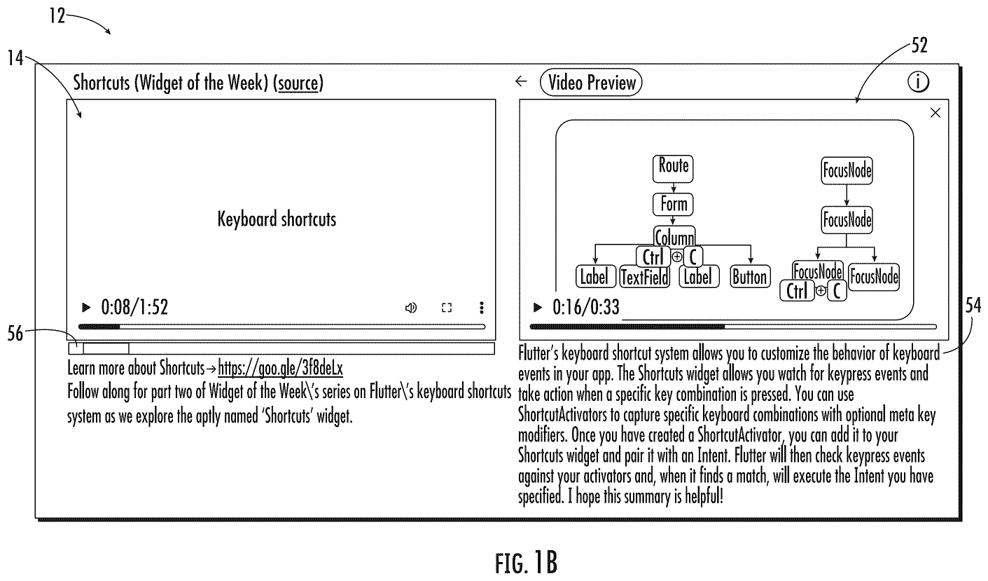

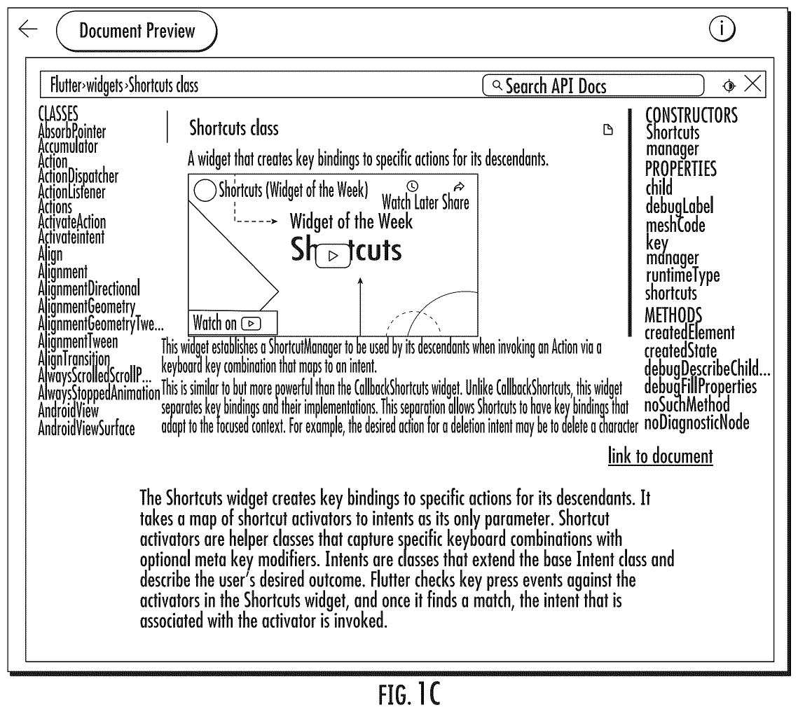

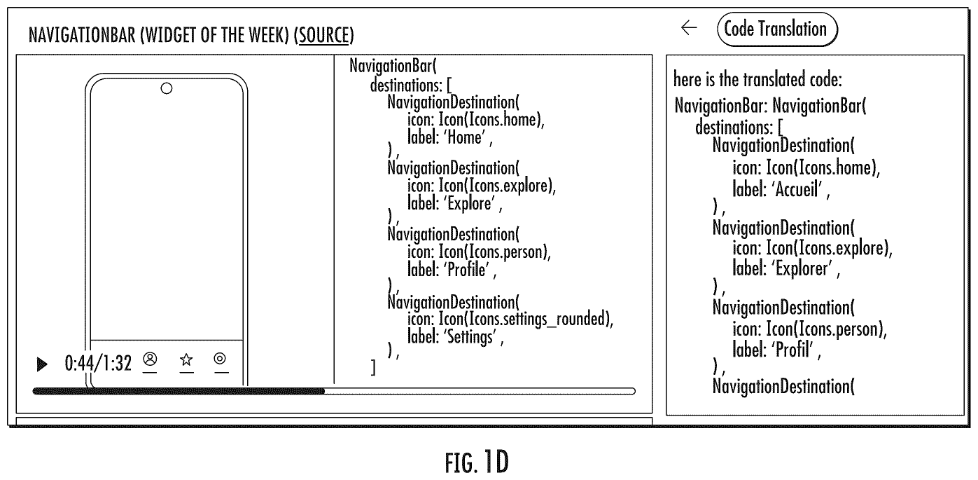

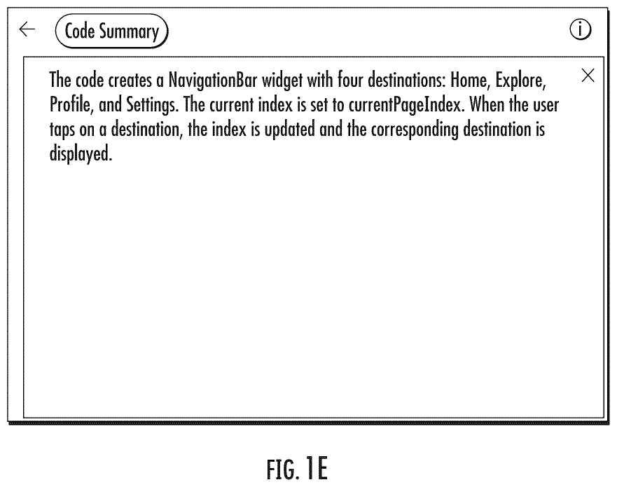

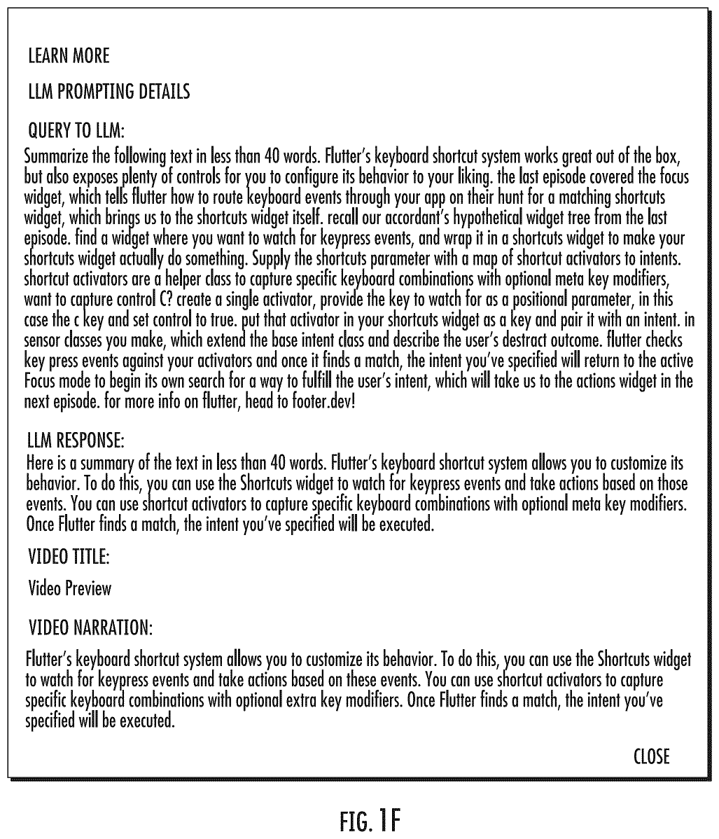

FIGS. 1A-B show example graphical user interfaces for enabling users to interact with support videos. Referring to FIG. 1A, the user interface 12 can present a main source video 14. The user interface 12 can also include the video title 18 and a video description 20 of the main source video 14.

The user interface 12 can also include a side panel 16 that enables access to a set of support videos (e.g., that were automatically generated as described herein). For example, the available support videos can be represented by user-selectable chips, such as, for example, chip 22. The support videos can be various forms of videos such as, for example, previews and/or question-answer videos. In some implementations, when a user hovers over a support video chip that corresponds to a question, a response preview can be provided in text, as shown at 24.

When a user clicks on a support video chip, the UI 14 can pause the main video 14 and play the selected support video. This is shown in FIG. 1B. Referring to FIG. 1B, viewers can either follow a Text-to-Speech (TTS) voiceover with a visual preview 52, or read the summary text 54 below the video. An indicator 56 can show the relevant segment in the source video 14.

As examples, referring to FIG. 1A, some examples of the support videos can be organized into four categories, which are provided as examples only:

Video Preview: Tutorial videos commonly contain an introduction, one to multiple sections of instructions, and an ending. For example, to help viewers obtain a gist of the main video, [Video Preview] provides a visual and text summary of the source video. The timeline highlights the most relevant section in the main video given their semantic similarity, from where the video frames are remixed. Viewers can jump to the moment and continue watching in the same video player.

Questions and Answers: It is common that a web document or a website provides a FAQ (frequently asked questions) page to answer common issues. Similarly, example systems described herein can provide a set of questions and answers, each as a video, derived from the source video. For example, viewers might be interested to learn [How do I create a shortcut activator?] or [What is the difference between a shortcut activator and an intent?] from a tutorial video on Flutter's “Shortcuts” widget. Each question can lead to a short video illustrating the answer.

Supplementary Materials: For external materials such as a link to the API document, [Document Preview] summarizes the content. As an example, FIG. 1C shows an example interface (support panel only) that displays example document preview content. Since a document may contain in-depth information, [Document Read Time] indicates the page length for a reference. In these cases, example systems proposed herein can narrate the summary while presenting the webpage snapshot with a link to the document.

Code Understanding: Programming tutorials frequently include a code walkthrough as a presentation or live coding in an IDE. For moments where the video shows a code snippet, example systems proposed herein reveals code-related assistance, such as [Code Translation] and [Code Summary]. Instead of narrating over the content, example systems proposed herein cam present the material as text, for viewers to focus on code understanding and can copy the snippet. As examples, FIG. 1D shows an example interface displaying example code translation content while FIG. 1E shows an example interface displaying example code summary content.

Transparency: Viewers can choose to reveal the source details to understand how the support videos are generated from the source video. For each support material, the information button can lead viewers to the source prompt and response that the example system makes to interact with the Large-Language Model, which can be helpful to clarify the context. As an example, FIG. 1F shows an example interface provided in response to selection of the information button.

The example interfaces shown in FIGS. 1A-F presents aggregated useful information derived from the source video and its description in the video player.

### Example Video Generation Systems

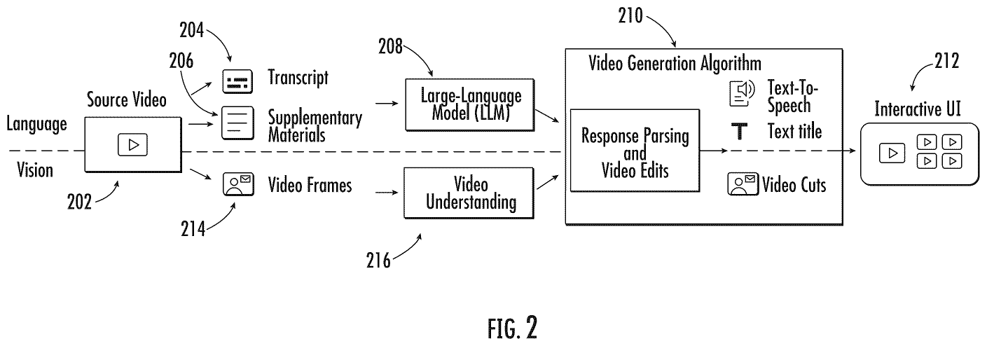

FIG. 2 illustrates an example data flow for automatically generating a support video from a source video. As illustrated in FIG. 2, a computing system can obtain source video 202. The computing system can extract one or more sets of textual content associated with the source video 202. For example, the textual content can include a transcript 204 and/or supplementary materials 206. As examples, the supplementary materials 206 can include metadata such as title or caption, user-generated content, code snippets, textual content from linked documents or URLs, and/or other forms of textual content.

Although one source video 202 is shown, it is also possible the content (e.g., transcript(s), supplementary material(s), visual content, etc.) can be extracted from multiple different source videos. Thus, some example applications can include generating one or more support videos (or other support content) from multiple source videos. For example, a single support video can be created that summarizes multiple source videos.

Referring still to FIG. 2, the computing system can process the one or more sets of textual content (e.g., and a prompt) with a generative sequence processing model 208 (e.g., LLM) to generate, as an output of the generative sequence processing model, additional textual content for a support video. As examples, the prompt can include an instruction to summarize the one or more sets of textual content; an instruction to explain one or more concepts included in the one or more sets of textual content; an instruction to generate one or more pairs of questions and answers regarding one or more concepts included in the one or more sets of textual content; and/or other instructions.

In some implementations, the computing system can also analyze one or more frames 214 of the source video to generate one or more sets of visual content data. For example, the computing system can apply one or more video understanding or computer vision tools 216 to generate the visual content data. As examples, application the video understanding and computer vision tools 216 can include applying a machine-learned face detection model to detect one or more faces in the one or more frames; detecting one or more video shots in the one or more frames; detecting one or more logos or icons in the one or more frames; performing optical character recognition on the video (e.g., to extract a code snippet or other text visualized in the video), and/or other tools or processes.

The computing system can input the additional textual content and/or the visual content to a video generation algorithm 210 to automatically generate the support video. As examples, the video generation algorithm 210 can include a number of tools to automatically generate the support video including, as examples, performing text-to-speech on the additional textual content to generate speech content for inclusion in the support video; generating a synthetic talking head that corresponds to the speech content; automatically selecting certain video cuts or shots from the source video to match with the additional textual content; and/or other operations. Although aspects of the present disclosure focus on the creation of a support video, the proposed techniques are not limited to generation of videos. For example, the same pipeline can be applied to automatically generate other forms of support content such as support text (e.g., explanations, summarizations, translations, etc.) and/or support audio content (e.g., audio speech of the additional textual content or other forms of audio content).

Referring still to FIG. 2, the support video can then be included in an interactive user interface 212. In some implementations, including the support video in the user interface 212 can include associating the support video with one or more timestamps of the source video 202, wherein the one or more timestamps correspond to the one or more sets of textual content. Then, during playback of the source video 202 at the one or more timestamps, a user interface element can be provided that enables viewing of the support video. Alternatively, the user interface element for the support video may be available during the entirety of playback of the source video 202.

Thus, some example systems described herein are able to generate support videos based on content understanding from a Large-Language Model (LLM) and Computer Vision techniques. Given an input source video, an example system retrieves the transcript, the video descriptions that contain URL links (such as to an API Document or a web tutorial), and annotates the frames to identify faces and text. The example system then generates prompts to an LLM for relevant information to the source video, which is used to generate a set of short-length videos. Example implementation details are discussed below.

### Example Video Metadata and Annotation

Some example systems aggregate a collection of video content in both the language and vision domains, including transcript, and video annotations, and/or related documents.

Transcript. Some example systems can take the video transcript as helpful information for content generation. The system acquires timecoded sentences, each with a start and end time mapped to the source video. For example, such a transcript can be generated from Automatic Speech Recognition (ASR) with incomplete sentences and lacks punctuation. To feed the transcript to the LLM as a text “document”, some example systems can use a finetuned language model to convert the raw transcript to complete punctuated sentences.

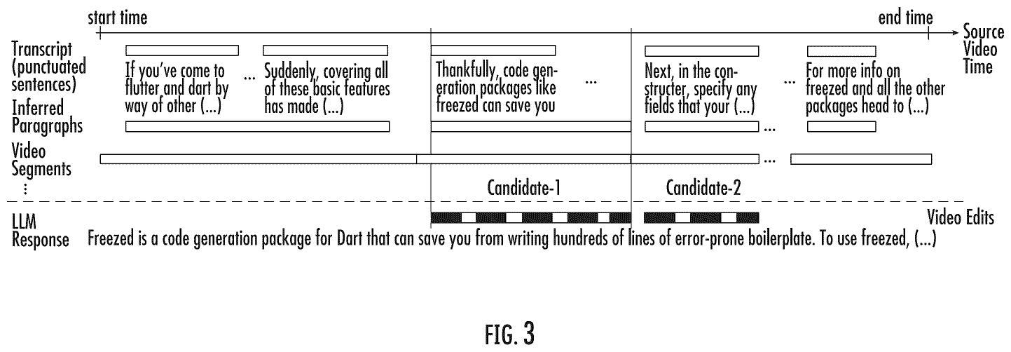

Video Analysis and Segmentation. Some example systems can analyze the video frames to annotate relevant information, including video shots (e.g., which separate a video into visual segments), face regions, and text. Each annotation can also be time-coded. In addition, to acquire the semantic segmentation of a video, some example systems prompt the LLM to suggest paragraphs from the punctuated transcript, for example: “Break this into paragraphs: [punctuated transcript]. Output as a Python list of sentence numbers by paragraphs. Name the list as “paragraphs”.”, where the punctuated transcript is labeling with sentence index as “[0] sentence-1, [1] sentence-2, . . . ”. Based on the LLM response, the computing system can time align each paragraph and their sentences with the source video, useful for later video editing. For example, a video starts with opening music, a verbal introduction (“If you've come to Flutter ( . . . )”), and then the main concept (“Thankfully, ( . . . )”), with time gaps in between (see FIG. 3). While the video frames appear to be similar, the instructions are semantically different.

Supplementary Materials. From the video description, some example systems can automatically retrieve all URLs but filter manually for links to an API document or a web tutorial. Some links, such as to a video playlist or subscriptions, can be discarded. Some example implementations retrieve a code repository or a playground linked from the video description and map code snippets to the video segments, often with modification for the exact alignment.

### Example Prompt Creation and Processing

Given the video metadata, a next step is to generate useful information from the source video and present it to viewers in the video player. To do so, some example implementations utilize a generative sequence processing model such as an LLM, which has been found able to powerfully perform tasks such as summarization and explanation. To interact with an LLM, some example implementations provide prompts with sufficient information and guidance. Two challenges on prompt design include (1) to acquire responses for following a technical tutorial video (e.g., programming tutorial), and (2) to acquire responses that can be shown to support the source video.

With respect to the first challenge, some example system can prompt the model to provide a summary, a preview, or a digest to the knowledge content, which has been found to be useful is useful. As another example, the model can be prompted to provide explanations, such as describing code behaviors or purposes. As yet another example, the model can be prompted to generate questions and answers to help learners clarify a concept or capture a quick takeaway.

The next challenge is to provide prompt instructions in order to receive results that can be used for video editing. Some example implementations therefore apply the following constraints: (1) The response can be restricted in word count, such as “summarize in less than 50 words”, with a goal to convert to concise narration. (2) The output format can be specified, such as “Output as a Python list”, “Do not show any link”, or “Estimate time in minutes”, for processing purposes. (3) The context can be set up as “Provide answers in a narrated form for verbal conversation” so that the text is more suitable for a voiceover.

Each prompt contains three components: (1) a prefix that is mostly an imperative sentence (e.g., “Summarize”, “Output”, or “Translate”) to provide a clear ask to LLM, (2) a target input, such as the video transcript or the URL link (or content retrieved therefrom), and (3) a suffix to specify the output format or the restrictions (e.g., “as a list”). In this way, the possible format of an LLM response can be controlled. Opening and closing sentences such as “Here is a summary” or “I hope this is helpful” can be removed.

Table 1 shows example prompts that can be combined with the video metadata and provided to an LLM or other model.

| Source | Goal | Prompt | Example Output |
|---|---|---|---|
| Transcript | Summary | Summarize the following text in less | Here is a summary |
| | | than 50 words: “[video transcript]”. Do | of (. . .) |
| | | not show any list or link. | |
| | FAQS | Output 10 questions and answers (each | Here are 10 |
| | | with 100 words) from the following text: | questions and |
| | | [video transcript]”. Output as a Python | answers (. . .) |
| | | list structure.” | |
| API | Summary | Summarize the page in less than 80 | Here is a summary |
| Document | | words: “[link to API doc]”. Do not show | of (. . .) |
| or Web | | any list or link. | |
| Tutorial | Read Time | Estimate the read time in minutes of this | The page you linked, |
| | | page for a fast reader: [link to API doc] | (. . .) |
| Code | Code | What does this code do? | The code creates |
| | Understanding | [code snippet] | (. . .) |
| | | Translate this code to French: | Here is the |
| | | [code snippet] | translation of the |
| | | | code to French: (. . .) |

For questions and answer responses, some example implementations directly convert the lists to video titles and narrations. For the rest of prompts, the video titles can be predefined, such as “Video Preview” or “Document Read Time” to the summarization prompt.

### Example Automatic Video Editing

For each model response, denoted as R, the computing system can perform a video generation algorithm to make automatic video edits for short-length video creation. First, some example implementations generate Text-to-Speech narration sentences extracted from R, with the narration denoted as R′.

Then, the system can acquire the duration T_{D} in seconds to fill the video frames. Some example implementations can identify the most relevant segments from the source video for editing. As an example, with an assumption that the narration from a video matches its visual content, some example systems can again rely on an LLM or other model for semantic similarity between shots or frames of the video and sentences of the narration R′. For example, for the narration R′ of a support video, the system can prompt an LLM to score the similarity between R′ and each paragraph Pᵢ in the punctuated video transcript using the following prompt: “Score the semantic similarity between the two paragraphs to zero to one: [0]R′, [1]Pᵢ.” Some example systems then rank the paragraphs to edit from the video segment Vₘ of the most relevant (top-scored) paragraph Pₘ. The system can then extract short jump cuts from Vₘ to linearly place onto the video timeline, and continue the process for the second top-scored Vₘ₋₁ or loop with Vₘ until the entire duration T_{D} is complete with video segments.

FIG. 3 shows an example of this process in which the video generation algorithm time-aligns the video metadata, including the transcript paragraphs and video annotations. For example, given a parsed LLM response as a support video narration, some example implementations identify the most relevant segments in the source video that are semantically similar based on the transcript, to make video cuts placed into the final support video.

Some example implementations intentionally respect the linearity of frames, shots, or segments from the source video, so as to avoid reordering the video segments when remixing for support video creation. For example, to avoid misalignment between the TTS voiceover and the faces in the remixed video, some example implementations exclude video segments of any faces. For source videos where the instructor's face is dominant, such as a Picture-in-Picture presentation showing the instructor's video talking over an IDE, further techniques can be performed to crop or inpaint the videos to remove the face, as necessary.

For certain prompts related to code understanding that might not be suitable for narration, a video or a TTS voiceover may not be rendered. Instead, some example implementations can present the original LLM responses in text. Finally, for prompts related to an API document or a web tutorial, some example implementations can automatically capture a screenshot of the page to be shown in the UI, which can play the TTS over the screenshot image with an embedded link to the web document.

### Example Devices and Systems

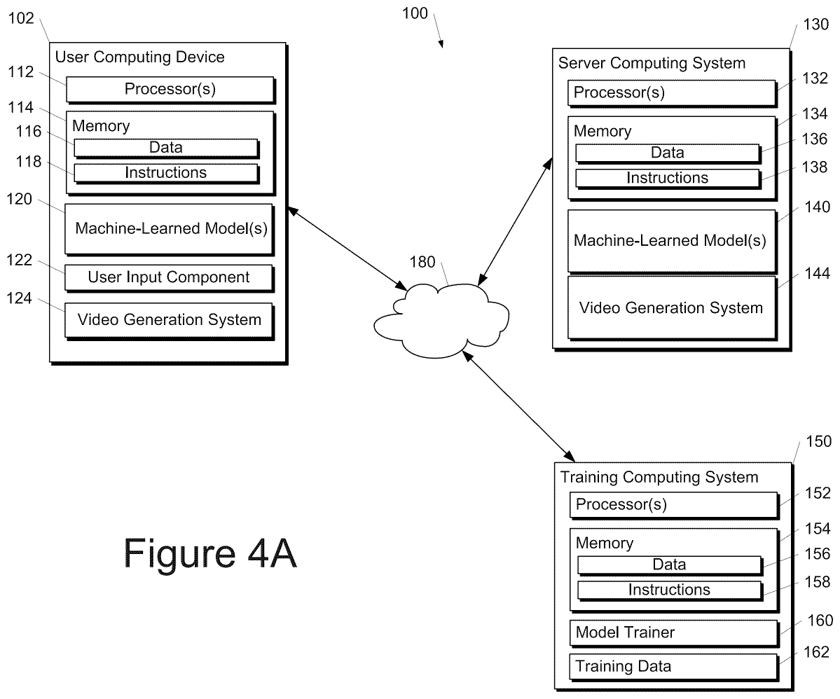

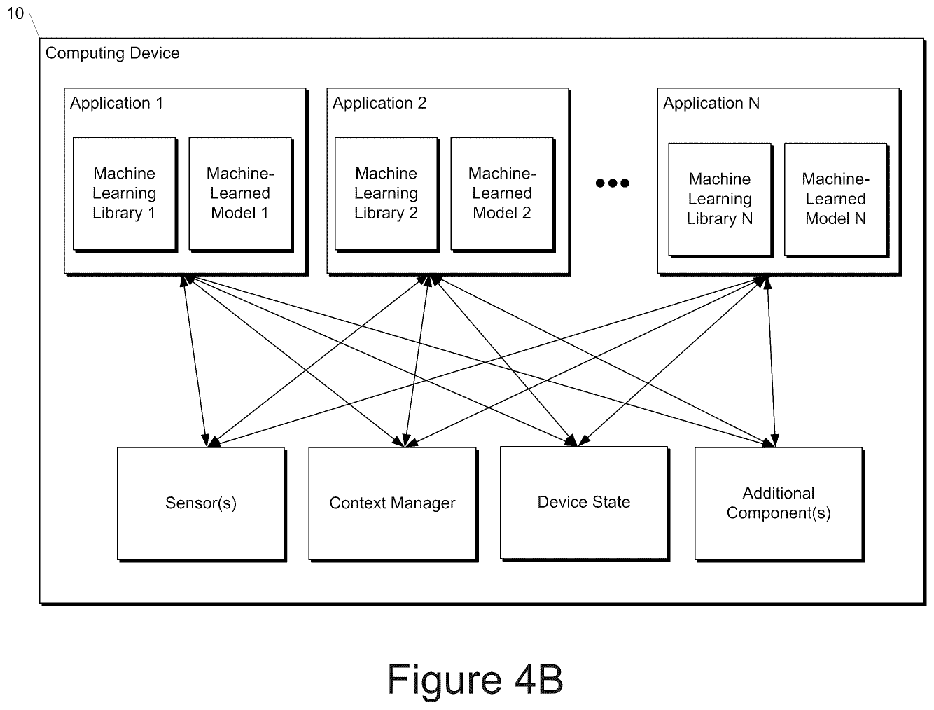

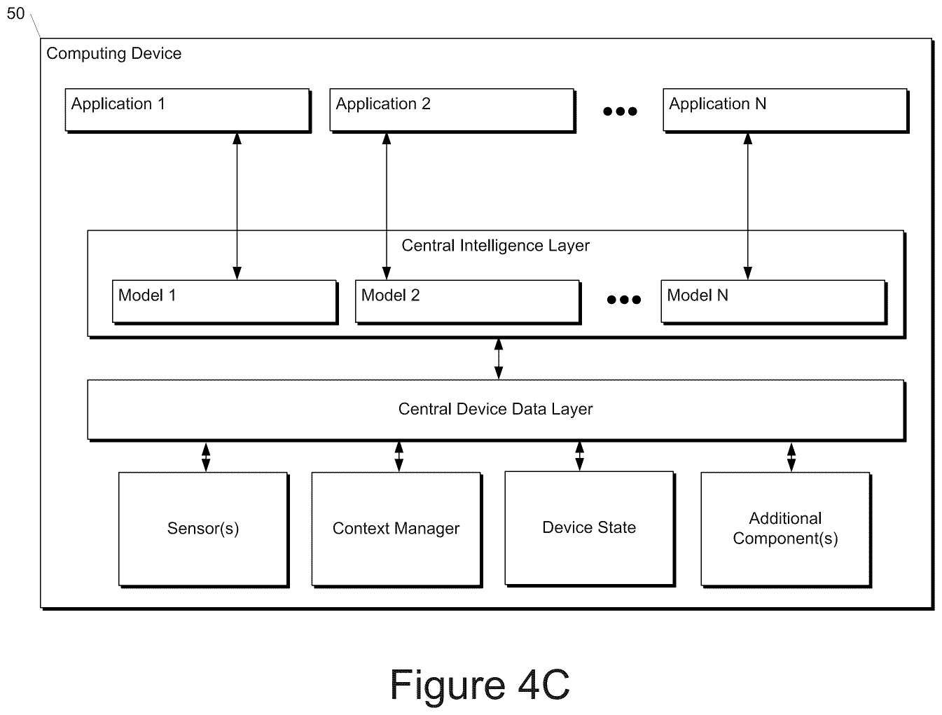

FIG. 4A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIG. 2.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

In some implementations, the user computing device 102 can store or include a video generation system 124. For example, the video generation system 124 can operate as shown or described herein such as shown and described with reference to FIGS. 1A-F, 2, and/or 3. Additionally or alternatively, a video generation system 144 can be included in or otherwise stored and implemented by the server computing system 130 that communicates with the user computing device 102 according to a client-server relationship. For example, the video generation system 144 can operate as shown or described herein such as shown and described with reference to FIGS. 1A-F, 2, and/or 3. Thus, video generation system 124 can be stored and implemented at the user computing device 102 and/or video generation system 144 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIG. 2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for automatic video generation, the method comprising:
obtaining, by a computing system comprising one or more computing devices, a source video;
extracting, by the computing system, one or more sets of textual content associated with the source video;
processing, by the computing system, the one or more sets of textual content with a generative sequence processing model to generate, as an output of the generative sequence processing model, additional textual content for a support video; and
inputting, by the computing system, the additional textual content to a video generation algorithm to automatically generate the support video.

2. The computer-implemented method of claim 1, wherein extracting, by the computing system, the one or more sets of textual content associated with the source video comprises extracting, by the computing system, a textual transcript of speech included within the source video.

3. The computer-implemented method of claim 1, wherein extracting, by the computing system, the one or more sets of textual content associated with the source video comprises extracting, by the computing system, a code snippet associated with the source video.

4. The computer-implemented method of claim 1, wherein extracting, by the computing system, the one or more sets of textual content associated with the source video comprises extracting, by the computing system, a linked document associated with the source video.

5. The computer-implemented method of claim 1, wherein processing, by the computing system, the one or more sets of textual content with the generative sequence processing model comprises processing, by the computing system, the one or more sets of textual content together and a prompt with the generative sequence processing model.

6. The computer-implemented method of claim 5, wherein the prompt comprises an instruction to summarize the one or more sets of textual content.

7. The computer-implemented method of claim 5, wherein the prompt comprises an instruction to explain one or more concepts included in the one or more sets of textual content.

8. The computer-implemented method of claim 5, wherein the prompt comprises an instruction to generate one or more pairs of questions and answers regarding one or more concepts included in the one or more sets of textual content.

9. The computer-implemented method of claim 1, further comprising:
analyzing, by the computing system, one or more frames of the source video to generate one or more sets of visual content data;
wherein inputting, by the computing system, the additional textual content to the video generation algorithm to automatically generate the support video comprises inputting, by the computing system, the additional textual content and the one or more sets of visual content data to the video generation algorithm to automatically generate the support video.

10. The computer-implemented method of claim 9, wherein analyzing, by the computing system, the one or more frames of the source video to generate one or more sets of visual content data comprises processing, by the computing system, the one or more frames of the source video with a machine-learned face detection model to detect one or more faces in the one or more frames.

11. The computer-implemented method of claim 9, wherein analyzing, by the computing system, the one or more frames of the source video to generate one or more sets of visual content data comprises detecting, by the computing system, one or more video shots in the one or more frames.

12. The computer-implemented method of claim 9, wherein analyzing, by the computing system, the one or more frames of the source video to generate one or more sets of visual content data comprises detecting, by the computing system, one or more logos or icons in the one or more frames.

13. The computer-implemented method of claim 9, wherein analyzing, by the computing system, the one or more frames of the source video to generate one or more sets of visual content data comprises detecting, by the computing system, one or more logos or icons in the one or more frames.

14. The computer-implemented method of claim 9, wherein analyzing, by the computing system, the one or more frames of the source video to generate one or more sets of visual content data comprises detecting, by the computing system, one or more sets of text or code in the one or more frames.

15. The computer-implemented method of claim 1, wherein the method further comprises performing, by the computing system, the video generation algorithm, wherein performing, by the computing system, the video generation algorithm comprises performing text-to-speech on the additional textual content to generate speech content for inclusion in the support video.

16. The computer-implemented method of claim 15, wherein performing, by the computing system, the video generation algorithm further comprises generating a synthetic talking head that corresponds to the speech content.

17. The computer-implemented method of claim 1, further comprising:
associating, by the computing system, the support video with one or more timestamps of the source video, wherein the one or more timestamps correspond to the one or more sets of textual content.

18. The computer-implemented method of claim 17, further comprising:
providing, by the computing system and during playback of the source video at the one or more timestamps, a user interface element that enables viewing of the support video.

19. The computer-implemented method of claim 1, wherein the generative sequence processing model comprises a transformer language model.

20. A computing system comprising one or more processors and one or more non-transitory computer-readable media that collectively store instructions that, when executed by the one or more processors, cause the computing system to perform operations, the operations comprising:
obtaining, by the computing system comprising, a source video;
extracting, by the computing system, one or more sets of textual content associated with the source video;
processing, by the computing system, the one or more sets of textual content with a generative sequence processing model to generate, as an output of the generative sequence processing model, additional textual content for a support video; and
inputting, by the computing system, the additional textual content to a video generation algorithm to automatically generate the support video.
